(19) United States
(12) Patent Application Publication
(10) Pub. No.: US 2023/0274321 A1
(43) Pub. Date: Aug. 31, 2023

(54) DETERMINING IMPACT OF A DONOR WITH RESPECT TO A TARGET ORGANIZATION

(71) Applicant: Auxilia, Centennial, CO (US)

(72) Inventor: Aaron Leo Gray, Hayward, CA (US)

(21) Appl. No.: 18/173,988

(22) Filed: Feb. 24, 2023

Related U.S. Application Data
(60) Provisional application No. 63/314,141, filed on Feb. 25, 2022.

(51) Int. Cl. G06Q 30/0279; G06Q 50/00

(52) U.S. Cl. CPC G06Q 30/0279; G06Q 50/01

(57) ABSTRACT

Techniques are described for monitoring and determining the influence of a donor on a target organization using blockchain technology. In an example embodiment, a system, comprises a memory that stores computer executable components; and a processor that executes the computer executable components stored in the memory, wherein the computer executable components comprise: a communication component that receives donor information over a period of time and a recording component that records the donor information in a blockchain stored on a blockchain network as the donor information is received over the period of time. The donor information can comprise social media data corresponding to a donor, and the recording component can record the social media data in the blockchain

### BACKGROUND

One or more embodiments described herein relate generally to systems for tracking donor activity in relation to a target organization. Embodiments relate to tracking donor information (e.g., social media impact and data), and more specifically, determining social media data, donor personal information, and donation data to determine a potential impact of a donor using blockchain technology.

### SUMMARY

The following presents a summary to provide a basic understanding of one or more embodiments described herein. This summary is not intended to identify key or critical elements or delineate any scope of the particular embodiments or any scope of the claims. The sole purpose of the summary is to present concepts in a simplified form as a prelude to the more detailed description that is presented later. In one or more embodiments described herein, systems, devices, computer-implemented methods, and/or computer program products that facilitate clustered encoding and decoding from one or more latent probability distributions are described.

According to an embodiment, a system can comprise a memory that stores computer executable components, and a processor that executes the computer executable components stored in the memory. The computer executable components can comprise a communication component that can receive donor information over a period of time, and a recording component that can record the donor information in a blockchain stored on a blockchain network as the donor information is received over the period of time.

In various implementations, the donor information can comprise social media data corresponding to a donor, and the recording component can record the social media data in the blockchain. The social media data can be captured via the communication component over the period of time. Additionally or alternatively, the donor information can comprise donor personal information corresponding to the donor, and the recording component can record the donor personal information in the blockchain. The donor personal information can be captured via the communication component over the period of time. In embodiments, the donor information can comprise donation data corresponding to the donor, and the recording component can record the donation data in the blockchain.

In some implementations, the period of time can comprise a duration such as to assess social media of a donor with respect to a target organization. The period of time can include a duration such that there is ample time to analyze social media postings and responses to such postings. In examples, responses to such postings can take one or more of a variety of durations depending on a multitude of factors (e.g., industry, product, social media platform, etc.).

According to another embodiment, a method can include receiving, by a system comprising a processor, donor information over a period of time; and recording, by the system, the donor information in a blockchain stored on a blockchain network as the donor information can be received over the period of time. Additionally, receiving the donor information can include collecting, by the system, social media data corresponding to a donor and recording, by the system, the social media data in the blockchain. Further, the method can include collecting, by the system, personal information corresponding to the donor and recording, by the system, the personal information in the blockchain. The method can additionally include collecting, by the system, donation data corresponding to the donor and recording, by the system, the donation data in the blockchain.

According to yet another embodiment, a non-transitory machine-readable storage medium comprising computer executable instructions that, when executed by a processor, facilitate performance of operations, can comprise receiving donor information over a period of time, and recording the donor information in a blockchain stored on a blockchain network as the donor information is received over the period of time. Additionally, the operations can further comprise collecting social media data corresponding to a donor and recoding the social media data in the blockchain. The operations can also comprise collecting donation data and donor personal information corresponding to the donor and recording the donation data and donor personal information in the blockchain.

In some embodiments, elements described in connection with the disclosed systems and devices can be embodied in different forms such as a computer-implemented method, a computer program product, or another form.

### DESCRIPTION OF THE DRAWINGS

FIG. 1 illustrates a high-level diagram of an example donor information environment in which information regarding the impact a donor has on a target organization can be tracked using blockchain technology in accordance with various aspects and embodiments described herein.

FIG. 2 illustrates an example system that facilitates tracking information regarding the impact a donor has on a target organization using blockchain technology in accordance with various aspects and embodiments described herein.

FIG. 3 illustrates an example blockchain network in accordance with various aspects and embodiments described herein.

FIG. 4 illustrates an example system that facilitates tracking information regarding the impact a donor has on a target organization using blockchain technology in accordance with various aspects and embodiments described herein.

FIG. 5 illustrates an example blockchain server device that facilitates tracking information regarding the impact a donor has on a target organization using blockchain technology in accordance with various aspects and embodiments described herein.

FIG. 6 illustrates an example blockchain in accordance with one or more embodiments described herein.

FIG. 7 illustrates a diagram of an example donor information data blockchain entry in accordance with one or more embodiments described herein.

FIG. 8 illustrates a diagram of an example donor information data blockchain entry verification mechanism in accordance with one or more embodiments described herein.

FIG. 9 illustrates a flow diagram of an example, non-limiting computer implemented method for tracking information regarding the impact a donor has on a target organization, in accordance with one or more embodiments described herein.

FIG. 10 illustrates an example schematic block diagram of a computing environment with which the disclosed subject matter can interact/be implemented at least in part, in accordance with various aspects and implementations of the subject disclosure.

FIG. 11 illustrates a block diagram representing an example computing environment into which aspects of the subject matter described herein may be incorporated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in this Detailed Description section.

In some cases, it can be desirable to track information and activity relating to donors with respect to a target organization to gain insight into donations or the effect a donor can have on a target organization. A target organization can be any organization or group (e.g., a network, a network of related companies/businesses, donation platforms, etc.) to benefit from actions of the donor. It can be desirable to track the effect of social media posts and/or donations by the donor (tangible and intangible) with respect to the target organization. For example, tangible donations can be monetary donations, and intangible donations can be social media posts. Further, it can also be desirable to gain donor insight, which can include donation history and/or other personal information about the donor. Tracking the activities of a donor can, in many cases, lead to informed decisions on methods and strategies to motivate donor activity for the target organization.

Nonetheless, even though results can be provided, a problem associated tracking donor information is that they lack the desired integration with social media to determine the influence of a donor from intangible and tangible donation perspectives. Further, determining the influence of a donor from an intangible donation perspective can include determining the marketing influence of the donor, tracking exposure generated from social media posts by the donor, and determining time donated. In many cases, the marketing influence of a donor can be important to track, as well as donation history, when analyzing the effect of a donor on the target organization.

Further, one or more embodiments described herein can be implemented to produce a solution that can facilitate the following processes: i) receiving, by a system comprising a processor, donor information over a period of time; and ii) recording, by the system, the donor information in a blockchain stored on a blockchain network as the donor information is received over the period of time. Additionally, the process can include determining, via an evaluation component, an overall influence score (e.g., a global influence score) of the donor by determining a social media score, an independent engagement score, and an influence score from the donor information stored in the blockchain. That is, embodiments described herein include one or more systems, computer implemented methods, apparatuses and/or computer program products that can facilitate one or more of the aforementioned processes.

The disclosed subject matter is directed to systems, computer-implemented methods, apparatus, and/or computer program products that can facilitate tracking donor information and social media influence on a target organization using blockchain technology.

Blockchain technology is widely regarded as a revolutionary, peer-to-peer, decentralized option for data organization; it allows for formation of decentralized monetary systems such as crypto-coins, smart contracts, and other resources that can be managed online such as smart property. Blockchain can be used in distributed ledger systems and allows different entities to exchange data and transactions quickly without intervention or verification by third parties. This can be accomplished through a shared data framework that utilizes computer algorithms to create real-time self-updates. Blockchain technology can also settle financial transactions without mediation from banks and other trusted institutions.

A common framework for blockchain is a decentralized database in which transactions are recorded using a virtually unmodifiable cryptographic signature. Records can be added to the decentralized database to create blocks that are protected against manipulation and alteration. Each block is connected to a previous block and has a timestamp of one or more transactions (e.g., the time at and/or about which such one or more transactions occurred), metadata characterizing the one or more transactions (e.g., amounts of cryptocurrencies involved in such one or more transactions, blockchain addresses from which and/or to which such amounts of cryptocurrencies were transferred during such one or more transactions), and/or a cryptographic hash of the previous electronic block. Because each electronic block can include a cryptographic hash of the previous electronic block, the blockchain can be resistant to retroactive tampering.

With this framework in mind, one or more embodiments described herein employ blockchain technology to track and record information regarding the impact a donor has on a target organization (e.g., a non-profit organization or network of organizations). The impact of a donor can include determining a potential marketing influence of the donor on the target organization. The donor information can include one or more varieties of information including, but not limited to, social media data, donor personal information, and donation data. With examples, the donor information can include any variety of information that relates to the social media presence or the potential social media impact of a donor.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

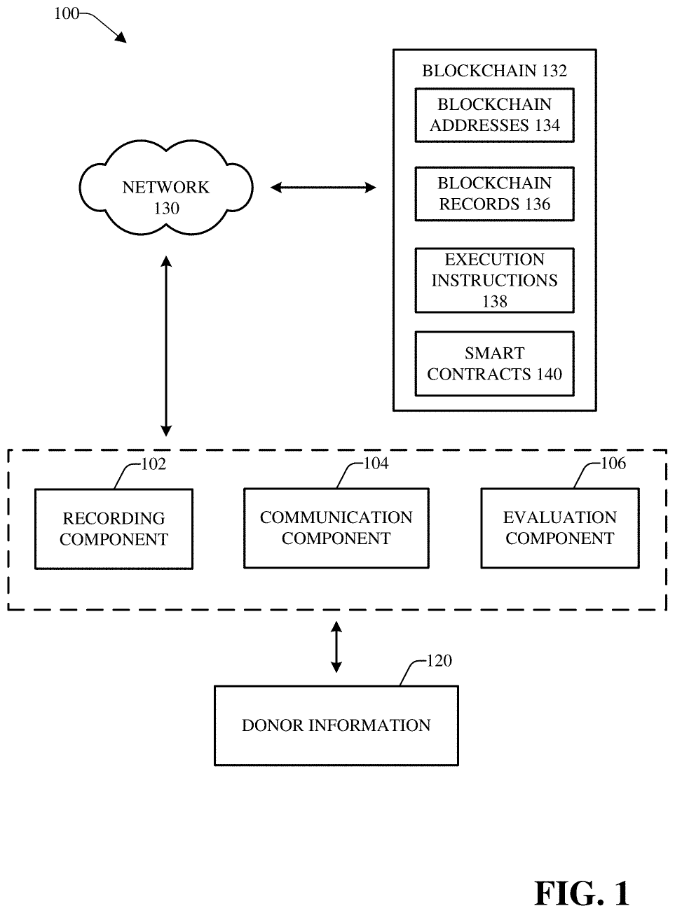

Turning now to the drawings, FIG. 1 illustrates a high-level diagram of an example information environment 100 in which donor information with respect to a target organization can be tracked using blockchain technology in accordance with various aspects and embodiments described herein. The information environment 100 includes a recording component 102, communication component 104, and an evaluation component 106 to analyze and collect donor information. The recording component 102, the communication component 104, and the evaluation component 106 can analyze and collect various sources of information to generate donor information 120 (e.g., information about a specific donor with resect to social media, marketing influence, donation history, etc.). The donor information 120 can be used to determine the likelihood of a particular donor to donate to a particular organization and the effect of a donation on the particular organization (e.g., tangible or intangible). It should be appreciated that the information environment illustrated in FIG. 1 is merely exemplary and intended to illustrate some example elements of an example information network used to communicate and record information that can be relevant to a donor with respect to the target organization. The specific components involved in the information network can vary, including the number and type of information sources.

Regardless of the specific components involved with the collection and recording of donor information, the disclosed subject matter provides techniques to capture and/or determine information (e.g., donor information 120) about the condition and context of the donor's activity over a time period (e.g., which can be any amount of time, such as the life of the donor, the life of the donor's family, the life of the target organization, the life of a social media platform, etc.) and record the information in a blockchain. In some embodiments, the disclosed techniques can also be extended to continue to track and record information regarding the impact a donor has on the target organization deriving from an originating social media post.

As illustrated in FIG. 1, the donor information 120 collected and/or determined for a donor over the period of time can be recorded on a blockchain 132 to provide an immutable record of the donor's activity over time (e.g., which can be a duration equal to the life of the donor and/or target organization, as described above). In its broadest sense, a blockchain 132 refers to a framework that supports a trusted ledger that is stored, maintained, and updated in a distributed manner in a peer-to-peer network. Though maintaining cryptocurrency transactions in the distributed ledger may be the most recognizable use of blockchain technology today, the ledger may be used in a variety of different fields where data of any type may be accessed where the accuracy of the data is assured. To facilitate this end, the blockchain 132 can include execution instructions 138 that define devices authorized to provide information to be recorded on the blockchain 132 as an authorized and verified source of the tracked donor information. The execution instructions 138 can further define and control what devices can write to the blockchain 132 (e.g., full nodes as described below), what information is recorded on the blockchain 132 and how (e.g., the hashing and verification protocols used). The exaction instructions 138 can also define entities authorized to access the blockchain 132 for read-only purposes.

The devices authorized to provide information to be recorded on the blockchain 132 can include various devices associated with social media, marketing influence, and other entities involved with social media and donor activity, that are configured to capture and/or determine relevant information regarding the activity of a donor (e.g., donor information 120) in an automated fashion that ensures the accuracy of the data (e.g., without manual data entry and/or involvement), and report the data to the blockchain 132 via a network 130. In this regard, the network 130 may be any of a variety of available networks, such as the Internet, and represents a worldwide collection of networks and gateways to support communications between devices connected to the network 130 (e.g., the Internet, a cellular network, a wide area network (WAN), a local area network (LAN), a personal area network (PAN) or any other suitable wired and/or wireless communication networks).

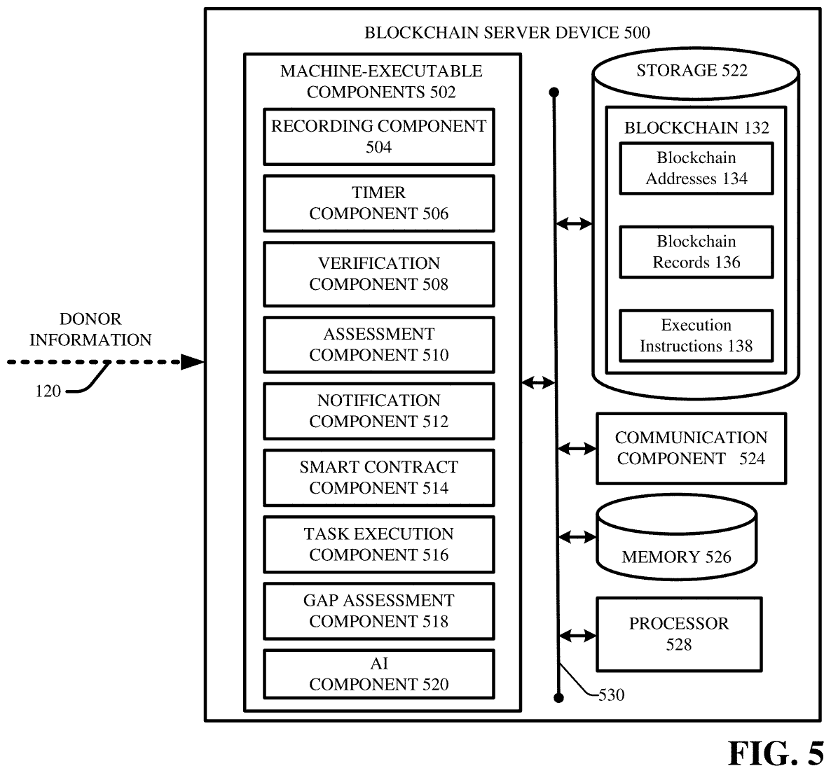

The blockchain 132 can include a set of blockchain address 134 and blockchain records 136. The blockchain records 136 can correspond to the information recorded on the blockchain 132 for respective donor information 120 using the disclosed techniques and the execution instructions 138. As applied to various embodiments of the disclosed subject matter, the blockchain records 136 can correspond to tracked social media data for respective donors. In various instances, the blockchain records 136 can be linked to corresponding blockchain addresses of respective social media postings for which the respective records pertain. For example, a blockchain record 136 recording the social media data of a donor can be linked to a corresponding blockchain address 134 associated with the donor. For example, each donor tracked by the system can be assigned a unique blockchain address of the set of blockchain addresses 134 that is tied to a unique identifier for the donor (e.g., a unique donor identifier (ID) such as a unique identification number or the like). In association with recording social media data for a particular donor, an authorized source of the information can identify the donor to which the information pertains (e.g., by the unique donor identifier) and/or the blockchain address associated with the donor. Information received for a particular donor from different authorized sources/devices can be linked to the same donor and/or the same blockchain address for the donor. The recorded data entry for the donor's activity can further be linked to its blockchain address. In this regard, the blockchain 132 can be considered as a digital record of the set of blockchain records 136 for a set of blockchain addresses 134 corresponding to different donors. In some embodiments, some or all of the tracked donor information 120 for respective donors can be stored in a data store (not shown) that is external to the blockchain and the blockchain records 136 can include hashed data entries that immutably link to the corresponding donor information 120 as aggregated and stored externally. The blockchain 132 can further include smart contracts 140 that can control transactions related to donations to various organizations (e.g., can be an accounting of funds/time donated to the target organization). For example, the blockchain records 136 can indicate a total sum of money donated by a donor, which can also reflect donations of relatives of the donor. Additional details regarding the smart contracts 140 are described infra with reference to FIG. 5.

The blockchain 132 can include any suitable blockchain capable of recording tracked donor information 120 in a verifiable and immutable manner. In various embodiments, the blockchain 132 can be a decentralized digital ledger made up of a sequence of electronic blocks. In various instances, any given electronic block can include a timestamp (e.g., time and/or date) associated with one or more blockchain records 136 corresponding to respective data entries of tracked social media data for a particular donor. In various cases, the given electronic block can also include metadata pertaining to the one or more blockchain records 136, such as the source of the data (e.g., the particular device authorized to write to the blockchain 132), the location of the data on external storage (in implementations in which some or all of the actual data is stored externally), a unique donor ID associated with the data, and/or respective blockchain addresses associated with the data. In some cases, the given electronic block can further include metadata pertaining to the one or more blockchain addresses, such as age of a blockchain address (e.g., days, months, and/or years since registration and/or creation of the blockchain address). Moreover, in various aspects, the given electronic block can include any suitable cryptographic hash of the preceding electronic block. In various instances, because each electronic block in the blockchain 132 can include a cryptographic hash of the previous electronic block, the blockchain 132 can be resistant to retroactive tampering and/or falsification.

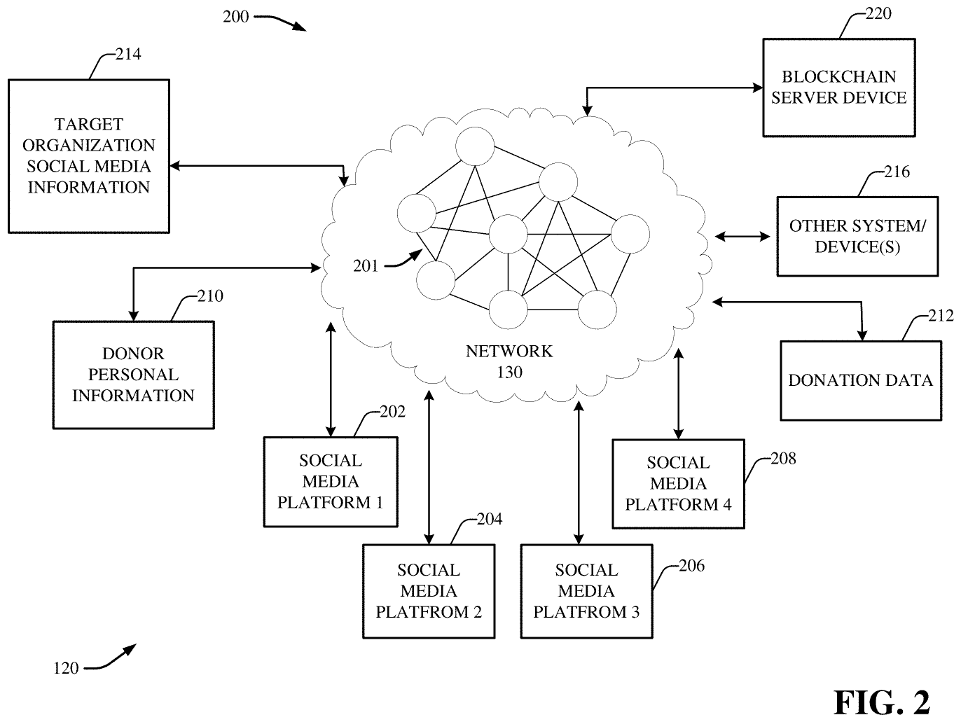

FIG. 2 illustrates an example system 200 that facilitates tracking information regarding the impact a donor has on the target organization using blockchain technology in accordance with various aspects and embodiments described herein. With reference to FIGS. 1 and 2, system 200 includes a plurality of different devices connected to network 130, wherein the network 130 can include a blockchain network 201 which comprises the blockchain 132. As noted above, the network 130 can be any of a variety of available networks, such as the Internet, and represents a worldwide collection of networks and gateways to support communications between devices connected to the network 130. The different devices can include various devices authorized to access and/or write to the blockchain 132 associated with the blockchain network 201 and provide all or portions of the tracked donor information 120 for respective donors tracked by the system 200. These devices can include, but are not limited to: devices coupled/connected to and/or connected with one or more social media networks (e.g., including a first social media platform 202, a second social media platform 204, a third social media platform 206, and a fourth social media platform 208) associated with the donor, one or more devices storing donor personal information 210 (e.g., contacts, connections, etc.), one or more devices storing donation data (e.g., a history of donations from the respective donor) 212, one or more devices storing target organization social media information 214, other systems/devices 216, and blockchain server device 220. These devices can respectively correspond to computing devices and/or IoT devices with suitable communication hardware and/or software that enables the respective devices to connect to the network 130 using any suitable wired or wireless communication technology.

For example, in some implementations, other systems/devices 216 can correspond to client devices or user equipment associated with users of the system 200. The other systems/devices 216 can also correspond to server devices associated with picture-sharing social media systems, video-sharing social media systems, text-sharing social media systems, professional and career focused social media systems, financial institutions, social media servers, and various other systems that may be employable by the blockchain network 201 to facilitate generating blockchain records and verifying blockchain records. In this regard, the other systems/devices 216 can include any suitable computing device or machine (e.g., a communication device, a desktop computer, a personal computer, a smartphone, a server, a virtual computing device, etc.), or interconnected group of computing devices/machine (e.g., interconnected via wired and/or wireless communication technologies) with connectivity to the network 130.

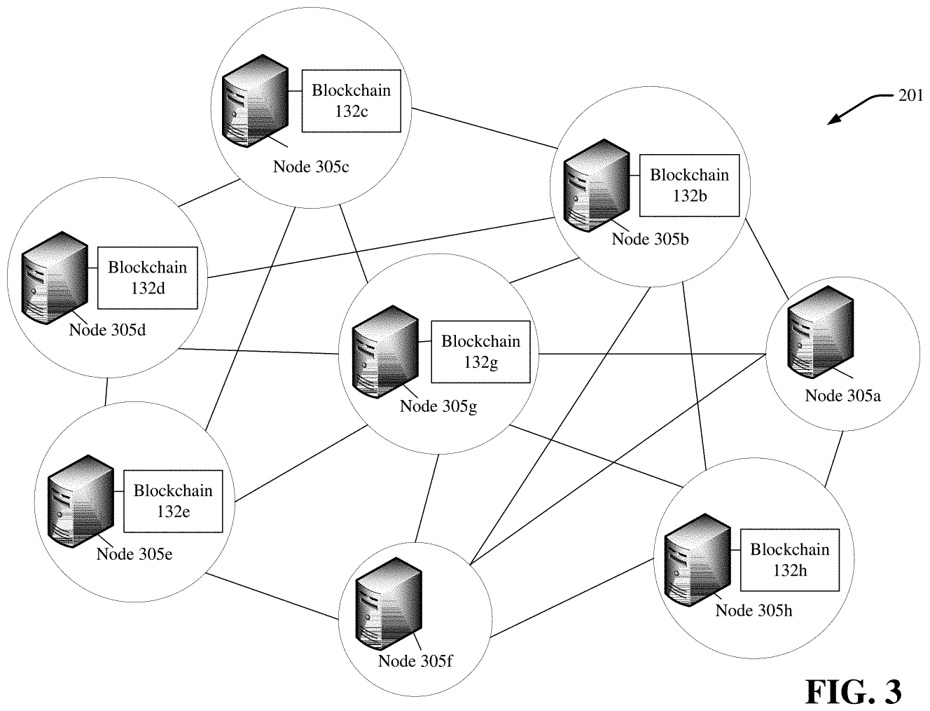

FIG. 3 illustrates an example blockchain network 201 in accordance with various aspects and embodiments described herein. With reference to FIGS. 1-3, as discussed above, the blockchain 132 can correspond to a distributed ledger that maintains timestamped records of the activity/influence of donors with respect to the target organization. The blockchain 132 can be stored, maintained, and updated in a peer-to-peer network, referred to as blockchain network 201. The blockchain network 201 can comprise a plurality of interconnected devices, referred to as blockchain nodes 305a-h. Each of the nodes 305a-h may comprise a computing device. In some implementations, one or more of the nodes 305a-h may comprise a pool of computing devices. The blockchain 132 may be stored at least at multiple nodes (or devices) of the blockchain network 201. Some or all of the nodes 305a-h may replicate and save an identical copy of the blockchain 132 respectively indicated with a corresponding subletter (e.g., blockchain 132b, blockchain 132c, blockchain 132d, blockchain 132e, blockchain 132g, and blockchain 132h). For example, FIG. 3 shows that the nodes 305b-e and 305g-h store copies of the blockchain 132. The nodes 305b-e and 305g-h may independently update their respective copies of the blockchain 132.

Blockchain nodes, for example, the nodes 305a-h, may be full nodes or lightweight nodes. Full nodes, such as the nodes 305b-e and 305g-h, may act as a server in the blockchain network 201 by storing a copy of the entire blockchain 132 and ensuring that donor records posted to the blockchain 132 are valid. The full nodes 305b-e and 305g-h may publish new blocks on the blockchain 132 corresponding to new donor data entries of the blockchain records 136. Lightweight nodes, such as the nodes 305a and 305f, may have fewer computing resources than full nodes. For example, IoT devices often act as lightweight nodes. The lightweight nodes may communicate with other nodes 305, provide the full nodes 305b-e and 305g-h with information, and query the status of a block of the blockchain 132 stored by the full nodes 305b-e and 305g-h. In this example, however, as shown in FIG. 3, the lightweight nodes 305a and 305f may not store a copy of the blockchain 132 and thus, may not publish new blocks on the blockchain 132.

In some embodiments, one or more of the devices connected to the network 130 illustrated in system 200 (e.g., the donor information comprising social media data, donor personal information, and donation data) may correspond to full nodes or lightweight nodes of the blockchain network 201. For example, in some embodiments, various IoT devices connected to the network 130 configured to capture and/or determine information regarding impact a donor has on the target organization can correspond to lightweight nodes of the blockchain network 201. With these embodiments, the respective devices may not store a copy of the blockchain 132 and thus may not directly publish new blocks on the blockchain 132. However, the respective devices can be configured to communicate the information to full nodes of the blockchain network which in turn publish (e.g., record/write, and store) the information to the blockchain 132 as new blocks of the blockchain records 136 in association with validating or verifying the information. For example, in various embodiments, the blockchain server device 220 can be or correspond to such a full node of the blockchain network 201. The blockchain network 201 can further include a plurality of full nodes corresponding to the blockchain server device 220. The respective full nodes can employ various predefined protocols for validating data entries to be published to the blockchain (e.g., based on the data being received from a verified/authorized device as included in metadata in the reported donor data or the like, and/or based on other criterion) defined in the blockchain execution instructions 138).

The blockchain network 201 and its associated blockchain 132 may be public (permissionless), federated or consortium, or private. If the blockchain network 201 is public, then any entity may read and write to the associated blockchain 132. However, the blockchain network 201 and its associated blockchain 132 may be federated or consortium and controlled by a single entity or group organization. For example, in one or more embodiments, the blockchain network 201 and its associated blockchain 132 can correspond to a consortium blockchain controlled by a group of entities consisting of the various different parties associated with the social media data (e.g., the respective servers and publishing devices associated with a social media platform). With these embodiments, the execution instructions 138 defining and controlling the rules and protocols regarding what devices are authorized sources of donor information to be recorded on the blockchain, the type of data to be recorded, the verification protocols required, the hashing protocol employed, and so on, can be mutually agreed to and accepted by the consortium. Still in other embodiments, the blockchain network 201 and its associated blockchain 132 may be private (permissioned) if access to the blockchain network 201 and the blockchain 132 is restricted to specific authorized entities, for example organizations or groups of individuals (e.g., official servers associated with respective social media platforms). Moreover, read permissions for the blockchain 132 may be public or restricted while write permissions may be restricted to a controlling or authorized entity.

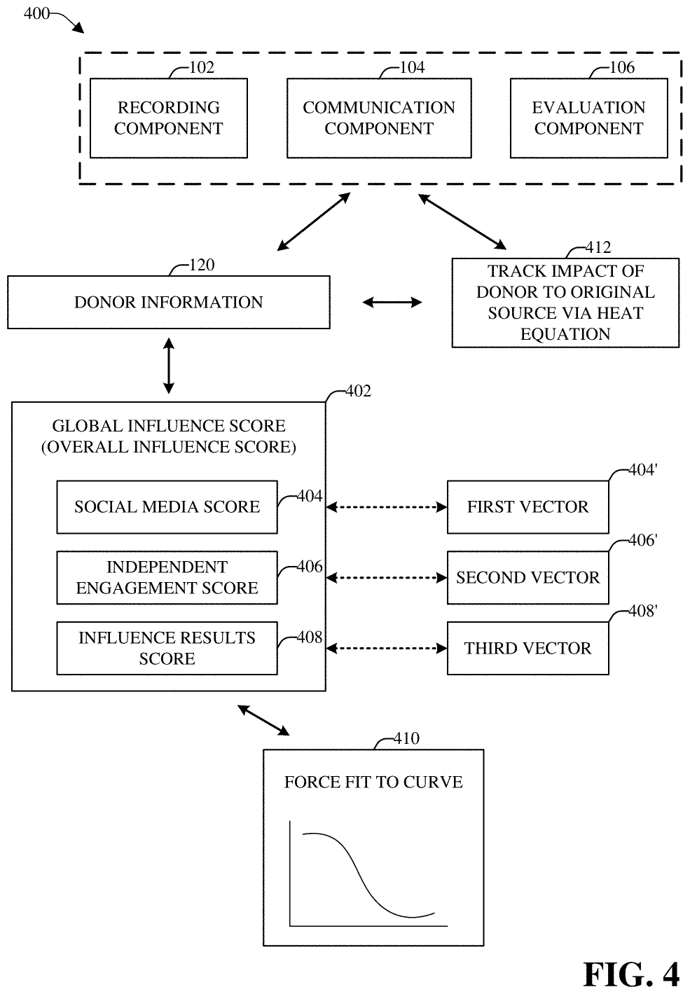

Turning next to FIG. 4, FIG. 4 illustrates an example system 400 that can be employed to determine and track the impact a donor has on a target organization via the recording component 102, the communication component 104, and the evaluation component 106. Further, the recording component 102, the communication component 104, and the evaluation component 106 can measure impact in one or more of a variety of manners, such as for example, by measuring/determining the social media platform used, number of individuals reached, number of generated reactions, type of reactions generated, and impact of the donor's actions, among other variables. The evaluation component can generate a global influence score 402 (e.g., an overall influence score) to indicate the relative impact a donor has on the target organization.

With embodiments, the global influence score 402 (e.g., an overall influence score) can be generated from the combination of one or more of a variety of scores/metrics associated with social media, donation history, and personal information of the donor. For example, and without limitation, the global influence score 402 can be a combination of a social media score 404 (social use), an independent engagement score 406 (social reach), and an influence results score 408 (ability to create action). The social media score 404 can include one or more of a variety of information, such as, the social media platforms that which the donor engages or participates in. Further, the social media score 404 can include weights (e.g., that the evaluation component 106 can assign/generate) for social media platforms that are more important than others to the target organization. Moreover, in embodiments, the social media platforms can be considered more important to the target organization if the social media platforms include a high number of public users, if the social media platforms are relevant for increasing social presence/exposure of the target organization, or for any other donation generating interest of the target organization. Additionally or alternatively, the social media score 404 can reflect the quantity or scale of social media platforms that which the donor engages with (e.g., participates in some part).

In examples, the independent engagement score 406 can include one or more of a variety of information related to the actions of the donor with respect to the target organization. For example and without limitation, the independent engagement score 406 can indicate the active nature of the donor on social media platforms, which can include determining the frequency that which a donor posts to social media and/or the quality of posts. Additionally, the independent engagement score 406 can reflect the actions performed by the donor when interacting with the social media of the target organization. The independent engagement score 406 can reflect: i) whether the donor forwarded a posting of the target organization; ii) whether the donor liked a posting of the target organization; iii) whether the donor shared a posting of the target organization; iv) whether the donor generated a text response to a posting of the target organization; v) the number of followers on the donor's social media platforms; and vi) the number of views for the donors action in regards to a posting of the target organization.

In embodiments, the influence results score 408 can be a measure of the impact of the social media postings made by the donor. Further, the influence results score 408 can include information indicating: i) the number of shares the donor's posting received with regards to the target organization; ii) the number of likes the donor's posting received with regards to the target organization; iii) the number of posts resulting from the donor's posting with regards to the target organization; and iv) donations received as a result of the donor's posting with regards to the target organization.

With embodiments, the evaluation component 106 can generate the social media score 404, the independent engagement score 406, and the influence score 408; and further, the evaluation component 106 can generate one or more vectors associated with the social media score 404, the independent engagement score 406, and the influence results score 408. The evaluation component 106 can generate a first vector 404′ associated with the social media score 404, can generate a second vector 406′ associated with the independent engagement score 406, and can generate a third vector 408 associated with the influence results score 408′. Additionally, the evaluation component 106 can assign weights to the social media score 404, the independent engagement score 406, and the influence score 408 (or the generated vectors 404′, 406′, 408′) depending on what factors are relevant to the target organization such that a higher global influence score 402 can be reflected for the donor (e.g., or within an accessible donor profile). The target organization can pre-determine the factors most relevant to their donation goal and establish weights accordingly; and such weights can vary depending on the donation or social exposure goals of the target organization.

Additionally, with embodiments, the social media score 404, the independent engagement score 406, and the influence results score 408 can be force fit (e.g., best fit) to a curve 410 to represent the global influence score 402, via the evaluation component 106. The scores 404, 406, 408 (e.g., the vectors 404′, 406′, 408′) can be force fit via one or more of a variety of data processing and smoothing algorithms/processes (e.g., at 410).

As described above, the evaluation component 106 can assign weighs to any of the identified factors/scores to reflect the interests/goals of the target organization. In some cases, the target organization can receive greater benefit from posts shared on one particular social media platform than on another social media platform. Additionally, the evaluation component 106 can assign weights based on the type of content shared by the donor. For example, posts indicating a willingness of the donor to donate to the target organization can be valued higher than posts that merely share a post originating from the target organization. In such a situation, the evaluation component 106 can consider the donor to be more impactful when sharing more direct and important posts of the target organization, than when sharing posts unrelated to philanthropy.

In embodiments, as illustrated in FIG. 4, the evaluation component 106 can track the impact of the donor generated from the donor's original post via a heat equation (∂u/∂t=Δu) at block 412. The heat equation can be used to track the impact generated from a post by tracking the donations and social media impact that occur as a result of the donor's original post or donation. The evaluation component 106 can track the trajectory of a donor's posting in relation to public exposure, other donations stemming from the original posting, and other factors over the period of time (e.g., which can be the life of the donor, the life of the social media post, etc.).

With embodiments, the evaluation component 106 can assign weights in relation to the manner of donation. For example, if a donor uses the portal associated with the target organization to donate (e.g., time or money), the donor can receive a higher global influence score 402 (e.g., as it can be beneficial for the target company).

FIG. 5 illustrates an example blockchain server device 500 that facilitates tracking information regarding the actions of a donor (e.g., with respect to donations and/or social media) using blockchain technology in accordance with various aspects and embodiments described herein. With reference to FIGS. 1-5, in one or more embodiments, blockchain server device 500 can correspond to blockchain server device 220 illustrated in system 200. It should be appreciated that the blockchain server device 500 (and blockchain server device 220) can correspond to one instance of a full node of the blockchain network 201 (e.g., of full nodes 305b-e and 305g-h) and that the blockchain network 201 can include a plurality of full nodes corresponding to blockchain server device 500.

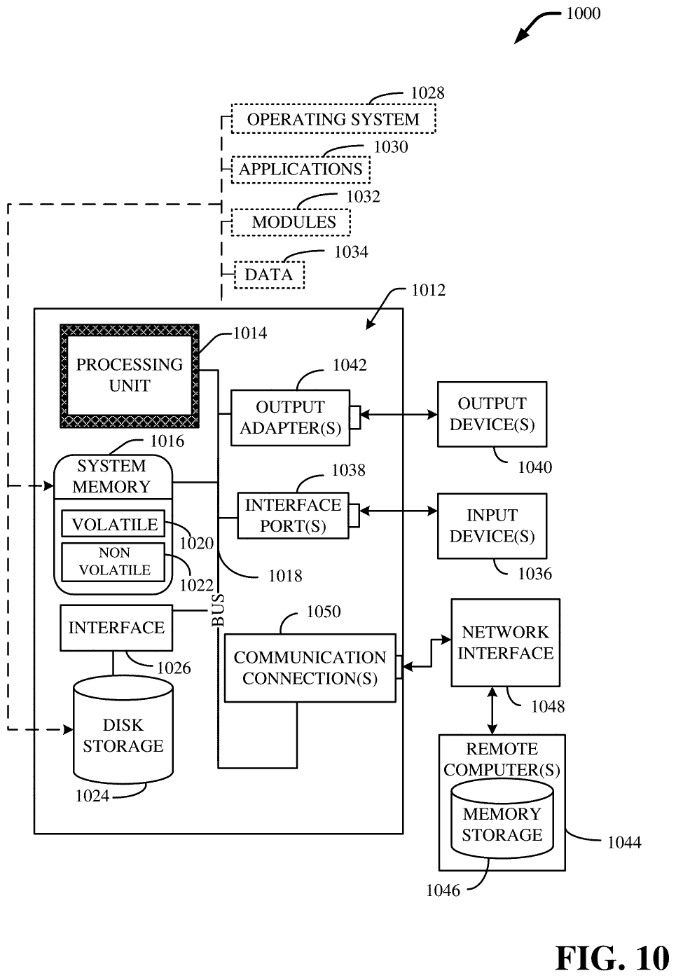

The blockchain server device 500 includes machine-executable components 502, storage 522, communication component 524, memory 526, processor 528 and a device bus 530 that couples the machine-executable components 502, the storage 522, the communication component 524, the memory 526 and the processor 528 to one another. In some embodiments, machine-executable components 502 can be stored in memory 528 and executed by the processor 528 to cause the blockchain server device 500 to perform operations described with respect to the corresponding components. In this regard, the blockchain server device 500 can correspond to any suitable computing device or machine (e.g., a communication device, a desktop computer, a personal computer, a smartphone, a server, a virtual computing device, etc.), or interconnected group of computing devices/machine (e.g., interconnected via wired and/or wireless communication technologies). Examples of said memory 526 and processor 528 as well as other suitable computer or computing-based elements, can be found with reference to FIG. 10 (e.g., processing unit 1014 and system memory 1046 respectively), and can be used in connection with implementing one or more of the systems or components shown and described in connection with FIG. 5, or other figures disclosed herein.

As described with reference to FIG. 3 and blockchain network 201, the blockchain 132 can be stored, updated and managed by a plurality of computing devices corresponding to blockchain server device 500 in a peer-to-peer network model. In the embodiment shown, the blockchain 132 is stored by the blockchain server device 500 in storage 522. The storage 522 can correspond to any suitable machine-readable media that can be accessed by the blockchain server device 500 and includes both volatile and non-volatile media, removable and non-removable media implemented in any method or technology for storage of information, such as computer-readable instructions, data structures, models, algorithms, program modules, or other data. Computer storage media can include, but is not limited to, random access memory (RAM), read only memory (ROM), erasable programmable read only memory (EPROM), flash memory or other memory technology, digital video disk (DVD) or other optical disk storage, magnetic cassettes, magnetic tape, magnetic disk storage or other magnetic storage devices, or any other medium which can be used to store the desired information, and which can be accessed by the blockchain server device 500.

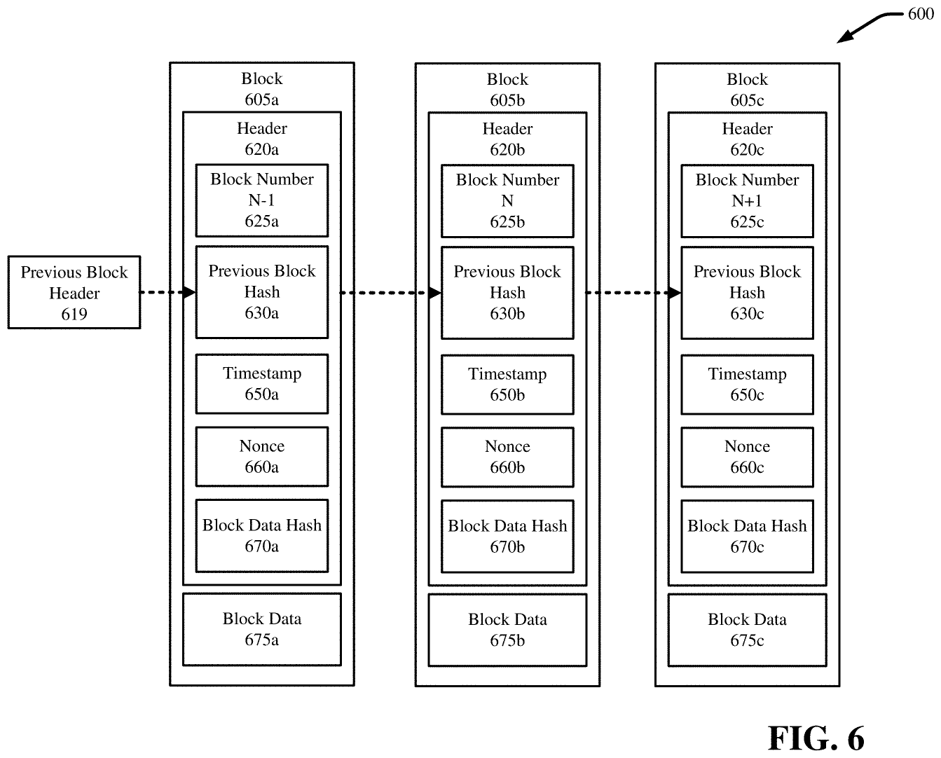

The communication component 524 can correspond to any suitable communication technology hardware and/or software that can perform wired and/or wireless communication of data between the blockchain server device 500 and other systems and devices. In this regard, the communication component 524 can provide for communicating information between the blockchain server device 500 and respective sources of donor information 120. The communication component 524 can also provide for communicating information between the blockchain server device 500 and other computing devices of the blockchain network 201. Examples of suitable communication technology hardware and/or software employable by the communication component 524 are described infra with reference to FIG. 6.

The machine-executable components 502 can include recording component 504, timer component 506, verification component 508, assessment component 510, notification component 512, task execution component 516, gap assessment component 518 and artificial intelligence (AI) component (AI component 520).

The recording component 504 can record received donor information 120 on the blockchain 132. The donor information 120 can correspond to any of the donor information 120 previously described (e.g., social media data, donor personal information, donation data, and target organization social media information, and the like). In this regard, the recording component 504 can receive donor information 120 from the various sources described herein. The donor information 120 can represent information pertaining to the donor received from any sources authorized to write to the blockchain 132 (e.g., such as one or more of a variety of social media networks).

In association with recording data entry record for a donor, the verification component 508 can perform a verification protocol to ensure each entry is verified. In various embodiments, the verification protocol can involve verifying the data entry based on a determination that the source of the data is an authorized source. In this regard, as described above, in some embodiments, each source of the donor information 120 can be associated with a unique ID which can be included with the received data. The verification component 508 can further determine whether the source if authorized based on information included in the execution instructions 138 identifying authorized sources by their respective unique IDs. In other embodiments, the verification component 508 can employ other verification techniques and protocols to verify a data entry for a donor on the blockchain. For example, other suitable verification protocols can involve usage of private and public keys, digital certificates and the like. In one or more embodiments, each time the recording component 504 generates a new data entry for a donor, the blockchain recording component 504 can create a new block on the blockchain, as illustrated in FIG. 10.

In this regard, FIG. 6 illustrates an example blockchain 600 in accordance with one or more embodiments described herein. In some embodiments, one or more aspects of blockchain 132 can correspond to blockchain 600. For example, one or more of the blockchain records 136 corresponding to tracked donor information 120 for respective donors tracked using the disclosed techniques may correspond to the structure of blockchain 600. In this regard, the blockchain 600 may comprise a plurality of blocks 605a, 605b, and 605c (generally referred to as blocks 605). The blockchain 1000 comprises a first block (not shown), sometimes referred to as the genesis block. Each of the blocks 605 may comprise a one or more blockchain records (e.g., of blockchain records 136) corresponding to a subset of tracked donor data for a particular donor or group of donors. The blocks 605 of the blockchain 600 may be linked together and cryptographically secured. In some cases, the post-quantum cryptographic algorithms that dynamically vary over time may be utilized to mitigate ability of quantum computing to break present cryptographic schemes. A copy of the blockchain 600 may be stored locally (e.g., at the blockchain server device 220), in the cloud, on a grid, for example by the nodes 305b-e and 305g-h, as a file or in a database.

Each of the blocks 605 may comprise one or more data fields. The organization of the blocks 605 within the blockchain 600 and the corresponding data fields may be implementation specific. As an example, the blocks 605 may comprise a respective header 620a, 620b, and 620c (generally referred to as headers 620) and block data 675a, 675b, and 675c (generally referred to as block data 675). The headers 620 may comprise metadata associated with their respective blocks 605. For example, the headers 620 may comprise a respective block number 625a, 625b, and 625c. As shown in FIG. 6, the block number 625a of the block 605a is N-1, the block number 625b of the block 605b is N, and the block number 625c of the block 605c is N+1. The headers 620 of the blocks 605 may include a data field comprising a block size (not shown).

The blocks 605 may be linked together and cryptographically secured. For example, the header 620b of the block N (block 605b) includes a data field (previous block hash 630b) comprising a hash representation of the previous block N-1′ s header 620a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 620c of the block N+1 (block 605c) includes a data field (previous block hash 630c) comprising a hash representation of block N′s (block 605b) header 620b.

The headers 620 of the blocks 605 may also include data fields comprising a hash representation of the block data, such as the block data hash 1200a-c. The block data hash 670a-c may be generated, for example, by a Merkle tree and by storing the hash or by using a hash that is based on all of the block data. The headers 620 of the blocks 605 may comprise a respective nonce 660a, 660b, and 660c. In some implementations, the value of the nonce 660a-c is an arbitrary string that is concatenated with (or appended to) the hash of the block. The headers 620 may comprise other data, such as a difficulty target.

The blocks 605 may comprise respective block data 675a, 675b, and 675c (generally referred to as block data 675). The block data 675 may comprise a record of validated donor data records for one or more donors that have been integrated into the blockchain 600. As discussed above, the block data 675 may include a variety of different types of data in addition to donor data 901. Block data 675 may include any data, such as text, audio, video, image, or file, that may be represented digitally and stored electronically.

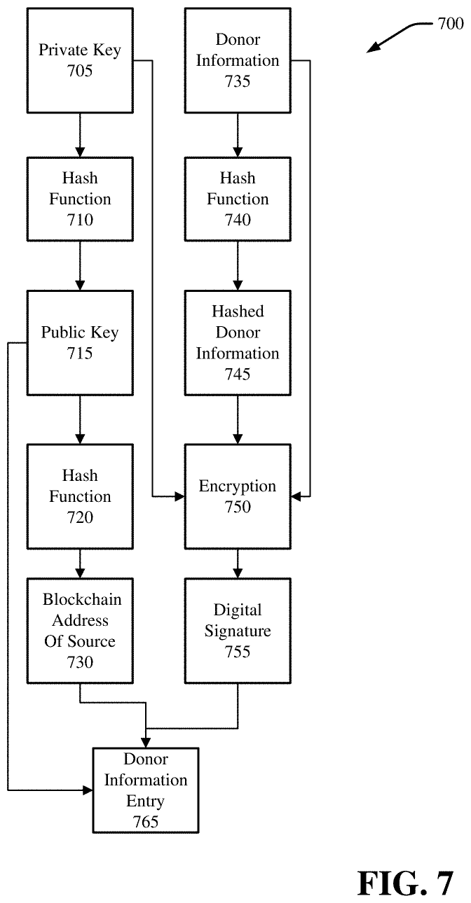

FIG. 7 illustrates a diagram of an example donor blockchain record entry operation 700 that may be performed by the recording component 504 in accordance with one or more embodiments described herein. The donor information entry 765 may correspond to one or more blockchain records 136 to be entered as a new bock in the blockchain (e.g., of blocks 1005a-c of blockchain 700 or the like). The donor information entry 765 may include a public key 715, a blockchain address 730 associated with the donor ID to which the record pertains, and a digital signature 755. In some embodiments, the recording component 504 may derive a public key 715 from a private key 705 provided by the source of the donor information 735 by applying a cryptographic hash function 710 to the private key 705. The cryptographic hash function 710 may be based on AES, SHA-2, SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3), Secure Hash Standard. The recording component 504 may derive an address or identifier for the donor ID, such as the blockchain address 730, by applying a hash function 720 to the public key 715. Briefly, a hash function is a function that may be used for mapping arbitrary size data to fixed size data. The value may also be referred to as a digest, a hash value, a hash code, or a hash. In order to indicate that the donor ID is the originator of the donor information entry 765, the recording component 504 may generate the digital signature 755 for the donor information 735 using the private key 705 of the corresponding donor and/or source of the donor information. The donor information 735 may include any elements of the donor information 120. Generating the digital signature 755 may include applying a hash function 740 to the donor information 735 resulting in hashed donor information 745. The hashed donor information 745 and the donor information 735 may be encrypted (via an encryption function 750) using the private key 705, resulting in the digital signature 755.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

With reference to FIGS. 3, 5 and 7, a donor information entry (e.g., donor information entry 765) may be broadcast by a blockchain server (e.g., blockchain server device 220) to multiple nodes 305 of the blockchain network 201 (e.g., via blockchain recording component 504). Typically, once the donor information data entry is broadcast or submitted to the blockchain network 201, it may be received by one or more of the nodes 305. Once the donor information data entry is received by the one or more nodes 305 of the blockchain network 201, it may be propagated by the receiving nodes 305 to other nodes 305 of the blockchain network 201.

The blockchain network 201 may operate according to a set of rules defined in the execution instructions 138. The rules may specify conditions under which a node may accept a data entry, a type of data entry that a node may accept, a type of compensation that a node receives for accepting and processing the data entry, etc. For example, a node may accept a data entry based on a transaction history, reputation, computational resources, relationships with service providers, etc. The rules may specify conditions for broadcasting a data entry to a node. For example, a data entry may be broadcast to one or more specific nodes based on criteria related to the node's geography, history, reputation, market conditions, docket/delay, technology platform. The rules may be dynamically modified or updated (e.g., turned on or off) to address issues such as latency, scalability and security conditions. A data entry may be broadcast to a subset of nodes as a form of compensation to entities associated with those nodes (e.g., through receipt of compensation for adding a block of one or more data entry to a blockchain).

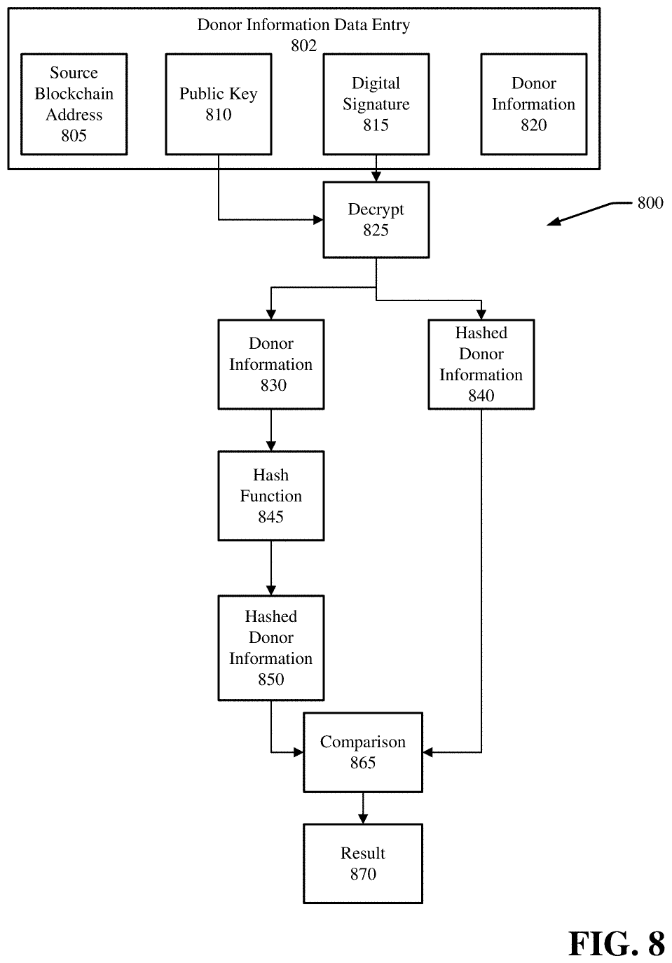

FIG. 8 illustrates a diagram of an example donor information data blockchain entry verification mechanism 800 in accordance with one or more embodiments described herein. Further, FIG. 8 shows an example donor information data entry 802 broadcast by the recording component 504 to the blockchain network 201. With reference to FIGS. 3, 5, 7 and 8, the donor information data entry 802 may correspond to donor information entry 765. The donor information data entry 802 may be broadcast to multiple nodes 305 of the blockchain network 201. Typically, once the data entry is broadcast or submitted to the blockchain network 201, it may be received by one or more of the nodes 305. Once the data entry is received by the one or more nodes 305 of the blockchain network 201, it may be propagated by the receiving nodes 305 to other nodes 305 of the blockchain network 201.

The donor information data entry 802 may include a blockchain address 805 for the source of the data and/or the donor to which the data corresponds, a public key 810, a digital signature 815, and the donor information 820. The receiving node (e.g., one or more of the nodes 305) may verify (e.g., using verification component 908) whether the donor information data entry 802 conforms to a pre-defined set of rules for the blockchain network 201 defined in the blockchain execution instructions 138. The node may also validate the donor information data entry 802 based on establishing data/source authenticity and authorization/verification. Source authenticity may be established by determining whether the source indicated by the transaction is in fact an authorized source. Source authenticity may be proven via cryptography, for example, asymmetric-key cryptography using a pair of keys, such as a public key and a private key. Data integrity of the donor information data entry 802 may be established by determining whether the donor information 820 associated with the donor information data entry 802 was modified in any way. When the recording component 504 creates the donor information data entry 802, it may indicate the source and/or donor to which the data entry pertains by including the digital signature 815.

At 825, the node may decrypt the digital signature 815 using the public key 810. A result of the decryption may include hashed donor information 840 and donor information 830. The node may generate hashed donor information 840 based on applying a hash function 845 to the donor information 830 and the second hashed donor information 850. If the result 870 of the comparison 865 indicates a match, then the data integrity of the donor information data entry 802 may be established and node may indicate that the donor information data entry 802 has been successfully validated. Otherwise, the data of the donor information data entry 802 may have been modified in some manner and the node may indicate that the donor information data entry 802 has not been successfully validated.

The notification component 512 can generate and send notifications to relevant entities (e.g., at corresponding user equipment associated with the entities) based on information recorded on the blockchain 132 satisfying a predefined notification criterion. The notifications can include any form of electronic notification capable of being sent to and rendered by a device (e.g., email, text message, etc.). For example, the notification component 512 can notify the target organization of a posting from a donor that is receiving high levels of exposure/sharing. In another example, the notification component 512 can notify the target organization that they should reach out to a specific donor based on the likelihood to donate (e.g., which can be based on a history of donations and social media data). The notification criterion can vary and be defined in the execution instructions.

The smart contract component 514 can control execution of smart contracts 140 defined on the blockchain 132. A smart contract is an agreement that is stored in a blockchain 132 and automatically executed (or self-executed) when the agreement's predetermined terms and conditions are met. The terms and conditions of the agreement may be visible to other users of the blockchain. When the pre-defined rules are satisfied, then the relevant code is automatically executed to perform a task or action defined by the contract for the parties involved. For example, the task or action may involve the transfer of money (e.g., digital currency or the like) from a financial account of one party to another based on satisfaction of the terms of the contract or another task. The task execution component 516 can facilitate executing tasks defined in smart contracts. The agreement may be written as a script using a programming language such as Java, C++, JavaScript, VBScript, PHP, Perl, Python, Ruby, ASP, Tcl, etc. The script may be uploaded to the blockchain as a transaction on the blockchain. The smart contract component 514 can also manage protocols for screening and parsing the information recoded on the blockchain 132 in association with determining when the rules and conditions of a smart contract have been met (or not), using a consensus model or another suitable model.

With reference again to FIG. 5, the gap assessment component 518 can facilitate filling gaps in donor records recorded on the blockchain 132. In particular, in an optimal usage scenario, the blockchain records for a particular donor will provide a complete timeline of all contextual events that occur for the donor over the course of the tracked period (e.g., the life of the donor or another timeframe). In various implementations however, there may be time segments over the tracked period where corresponding donor information 120 is not received due to various reasons. For example, the source of the data (e.g., the social media network and/or device) may not be communicatively connected to the network 130 to provide the data due to a technical communication issue. In another example, a source to provide the data may not be activated or available (e.g., in situations where donors lack a degree of social media platform participation). Various other reasons for missing donor information data are envisioned.

Various aspects of the disclosed subject matter can employ machine learning (ML) and artificial intelligence (AI) to automatically generate inferences and predictions regarding the impact a donor has on the target organization from donations and marketing influence described herein (e.g., via the social media score 404, the independent engagement score 406, and the influence results score 408). To facilitate this end, the machine-executable components 502 can include AI component 520. In this regard, the AI component 520 can employ ML to facilitate various aspects the assessments performed by the assessment component 510. With examples, the AI component 520 can be coupled with the evaluation component such that ML/AI can be implemented in determining the global influence score 402 of a donor. The AI component 520 can also employ ML and AI techniques to determine inferences regarding the gap assessment performed by the gap assessment component 518. For example, the AI component 520 can employ AI and ML to identify additional sources of donor information 120 to fill a gap timeframe associated with a particular donor over which other contextual event data was not received. The AI component 520 can also facilitate identifying gap timeframes where social media data is not recorded for the donor.

To facilitate this end, AI component 520 can perform learning with respect to any and all of the data received by the blockchain server device 500 and/or recorded on the blockchain 132 (e.g., the blockchain address 134, the blockchain records 136, the execution instructions 138, and the smart contracts 140). The AI component 520 can also evaluate relevant information provided by other systems/devices 216. Hereinafter, any information received the blockchain server device 500, stored by the blockchain server device 500 and/or accessible to the blockchain server device 500 is collectively referred to as “collective machine learning data” for the AI component 520.

It should be appreciated that AI component 520 can perform learning associated with the collective machine learning data explicitly or implicitly. Learning and/or determining inferences by the AI component 520 can facilitate identification and/or classification of different patterns associated with the collective machine learning data, determining one or more rules associated with collective machine learning data, and/or determining one or more relationships associated with the collective machine learning data that influence determinations and inferences by the assessment component 510 and the gap assessment component 518. The AI component 520 can also employ an automatic classification system and/or an automatic classification process to facilitate identification and/or classification of different patterns associated with the collective machine learning data, determining one or more rules associated with collective machine learning data, and/or determining one or more relationships associated with the collective machine learning data that influence determinations and inferences by the assessment component 510 and the gap assessment component 518. For example, the AI component 520 can employ a probabilistic and/or statistical-based analysis (e.g., factoring into the analysis utilities and costs) to learn one or more patterns associated with the collective machine learning data, determining one or more rules associated with collective machine learning data, and/or determining one or more relationships associated with the collective machine learning data that influence determinations and inferences by the assessment component 510 and the gap assessment component 518. The AI component 520 can employ, for example, a support vector machine (SVM) classifier to facilitate learning patterns associated with the collective machine learning data, determining one or more rules associated with collective machine learning data, and/or determining one or more relationships associated with the collective machine learning data that influence determinations and inferences by the assessment component 510 and the gap assessment component 518. Additionally, or alternatively, the AI component 520 an employ other classification techniques associated with Bayesian networks, decision trees and/or probabilistic classification models. Classifiers employed by the AI component 520 can be explicitly trained (e.g., via a generic training data) as well as implicitly trained (e.g., via observing user behavior, receiving extrinsic information). For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

In an aspect, the AI component 520 can utilize, in part, inference-based schemes to facilitate learning one or more patterns associated with the collective machine learning data, determining one or more rules associated with collective machine learning data, and/or determining one or more relationships associated with the collective machine learning data that influence determinations and inferences by the assessment component 510 and the gap assessment component 518. The AI component 520 can further employ any suitable machine-learning based techniques, statistical-based techniques and/or probabilistic-based techniques. For example, the AI component 520 can employ expert systems, fuzzy logic, SVMs, Hidden Markov Models (HMIs), greedy search algorithms, rule-based systems, Bayesian models (e.g., Bayesian networks), neural networks, other non-linear training techniques, data fusion, utility-based analytical systems, systems employing Bayesian models, etc. In another aspect, the AI component 520 can perform a set of machine learning computations associated with collective machine learning data. For example, the AI component 520 can perform a set of clustering machine learning computations, a set of decision tree machine learning computations, a set of instance- based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations. Any rules, patterns, and/or correlations learned by the AI component 520 with respect to the collective machine learning data can further be stored by the blockchain server device 500 in memory 526 and/or storage 522 and shared with other nodes of the blockchain network 201.

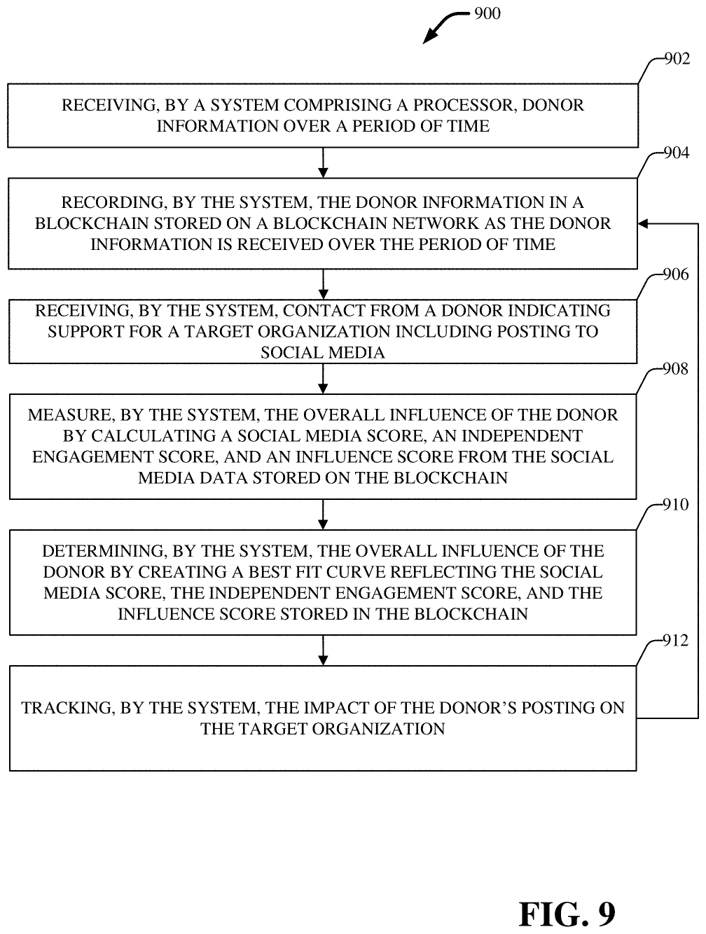

FIG. 9 illustrates an example computer-implemented method 900 for tracking the impact a donor has on the target organization from donations and marketing influence on behalf of the target organization. Method 900 comprises an example computer-implemented process that can be executed via one or more blockchain server devices of a blockchain network 201, such as blockchain server device 500. Repetitive description of like elements employed in respective embodiments is omitted for sake of brevity.

In accordance with method 900, at 902 a system comprising a processor (e.g., blockchain server device 500 or the like) can receive donor information over a period of time (e.g., about 12-15 months, or more or less). Additionally, the method 900 at 904, can include recording, by the system, the donor information in a blockchain stored on a blockchain network as the donor information is received over a period of time.

At 906, the non-limiting method 900 can comprise receiving, by the system, contact information from a donor indicating support for a target organization including posting to social media. The method 900 can include receiving a request or communication (e.g., social media post) from a donor indicating support (e.g., can be considered the original post from which impact can be determined) or a desire to support the target organization. The method 900 can include receiving the request in one or more of a variety of manners. For example and without limitation, the method 900 can include receiving the request via social media (e.g., one or more social media platforms) or via direct communication with the target organization.

At 908, the non-limiting method 900 can comprise measuring, by the system, the overall influence (e.g., the global influence score) of the donor by calculating a social media score, an independent engagement score, and an influence score from the social media data stored on the blockchain. The non-limiting method 900 can comprise generating a first vector from the social media score, a second vector from the independent engagement score, and a third vector from the influence score. The non-limiting method 900 can comprise assigning weights to the first vector (e.g., the social media score), the second vector (e.g., the independent engagement score), and the third vector (e.g., the influence score) based on social media factors that can be relevant to the target organization.

In embodiments, when no social media can be identified, the method can include initializing the social media score, the independent engagement score, and the influence score to an initial value (e.g., a zero value). Thereafter, the overall influence (e.g., the global influence score) of the donor can be aggregated over time through a variety of iterations of steps 904, 906, 908, 910, 912.

At 910, the non-limiting method 900 can comprise determining, by the system, the overall influence of the donor by creating a best fit curve reflecting the social media score, the independent engagement score, and the influence score stored in the blockchain. The non-limiting method 900 can comprise combining and fitting the first vector, the second vector, and the third vector to a best-fit curve to reflect the global influence score of the donor.

At 912, the non-limiting method 900 can comprise tracking, by the system, the impact of the donor's posting on the target organization (via a heat equation). The non-limiting method 900 can include repeating step 904 after step 912 to build donor information (e.g., a donor information profile) for one or more donors with respect to the target organization.

For simplicity of explanation, the computer-implemented and non-computer- implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

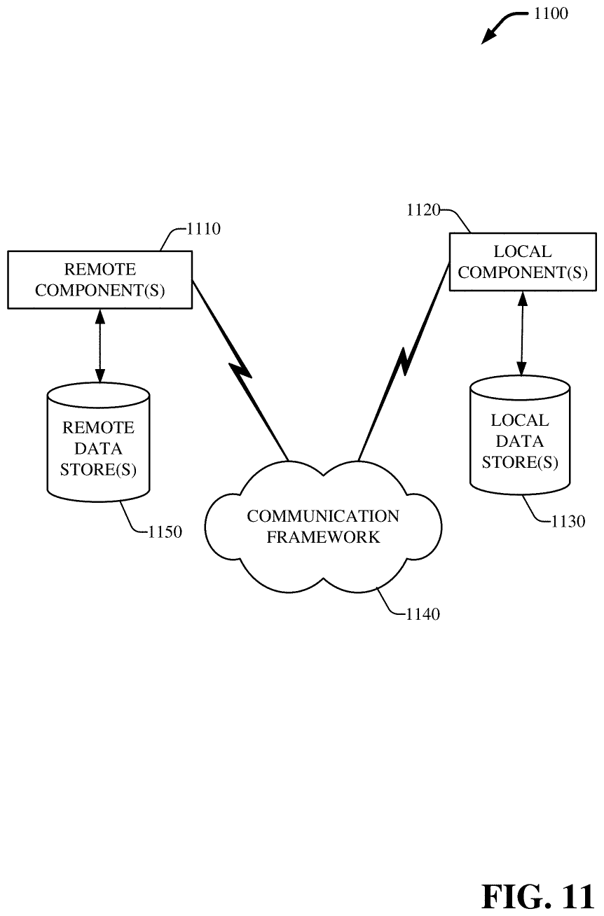

Turning next to FIGS. 10 and 11, a detailed description is provided of additional context for the one or more embodiments described herein with FIGS. 1-9.

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity. With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), Small Computer Systems Interface (SCSI), a controller area network (CAN) bus, and a local interconnect network (LIN) bus. The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012. System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1648 to the system bus 1018. While communication connection 1050 is shown for illustrative clarity inside computer 1012, it can also be external to computer 1012. The hardware/software for connection to the network interface 1048 can also include, for example purposes only, internal and external technologies such as, modems including regular telephone grade modems, cable modems and DSL modems, ISDN adapters, and Ethernet cards.

The illustrated embodiments described herein can be employed relative to distributed computing environments (e.g., cloud computing environments), such as described below with respect to FIG. 11, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment described below with reference to illustration 1100 of FIG. 11. For instance, one or more embodiments described herein and/or components thereof can employ such one or more resources to execute one or more: mathematical function, calculation and/or equation; computing and/or processing script; algorithm; model (e.g., artificial intelligence (AI) model, machine learning (ML) model, deep learning (DL) model, and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed. That is, the one or more embodiments described herein can be implemented in a local environment only, and/or a non-cloud-integrated distributed environment, for example.

A cloud computing environment can provide one or more of low coupling, modularity and/or semantic interoperability. At the heart of cloud computing is an infrastructure that includes a network of interconnected aspects.

Moreover, the non-limiting systems described herein can be associated with and/or be included in cloud-based and/or partially-cloud-based system.

Referring now to details of one or more elements illustrated at FIG. 11, an illustrative cloud computing environment 1100 is depicted. FIG. 11 is a schematic block diagram of a computing environment 1100 with which the disclosed subject matter can interact. The system comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, radio access network devices, gateway devices, femtocell devices, servers, etc.

The system 1100 also comprises one or more local component(s) 1120. The local component(s) 1120 can be hardware and/or software (e.g., threads, processes, computing devices). In some embodiments, local component(s) 1120 can comprise an automatic scaling component and/or programs that communicate / use the remote resources 1110 and 1120, etc., connected to a remotely located distributed computing system via communication framework 1140.

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures, and/or the like that perform particular tasks and/or implement particular abstract data types. Moreover, the aforementioned computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes”, “has”, “possesses”, and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a communication component that receives donor information over a period of time; and
a recording component that records the donor information in a blockchain stored on a blockchain network as the donor information is received over the period of time.

2. The system of claim 1, wherein the donor information comprises social media data corresponding to a donor, and wherein the recording component records the social media data in the blockchain.

3. The system of claim 2, wherein the donor information comprises donor personal information corresponding to the donor, and wherein the recording component records the donor personal information in the blockchain.

4. The system of claim 3, wherein the donor information comprises donation data corresponding to the donor, and wherein the recording component records the donation data in the blockchain.

5. The system of claim 4, further comprising an evaluation component that determines an overall influence score of the donor by determining a social media score, an independent engagement score, and an influence score from the donor information stored in the blockchain.

6. The system of claim 5, wherein the evaluation component determines the overall influence score of the donor by creating a best fit curve reflecting the social media score, the independent engagement score, and the influence score from the donor information stored in the blockchain.

7. The system of claim 6, wherein the evaluation component monitors both tangible and intangible donations corresponding to the donor.

8. The system of claim 6, wherein the evaluation component monitors the donor information with respect to social media information of a target organization.

9. A method, comprising:
receiving, by a system comprising a processor, donor information over a period of time; and
recording, by the system, the donor information in a blockchain stored on a blockchain network as the donor information is received over the period of time.

10. The method of claim 9, further comprising collecting, by the system, social media data corresponding to a donor, and recording, by the system, the social medial data in the blockchain.

11. The method of claim 10, further comprising collecting, by the system, donor personal information corresponding to the donor, and recoding, by the system, the donor personal information in the blockchain.

12. The method of claim 11, further comprising collecting, by the system, donation data corresponding to the donor, and recording, by the system, the donation data in the blockchain.

13. The method of claim 12, further comprising determining, by the system, an overall influence score of the donor by calculating a social media score, an independent engagement score, and an influence score from the social media data stored in the blockchain.

14. The method of claim 13, further comprising determining, by the system, the overall influence score of the donor by creating a best fit curve reflecting the social media score, the independent engagement score, and the influence score stored in the blockchain.

15. The method of claim 14, further comprising monitoring, by the system, both tangible and intangible donations corresponding to the donor.

16. The method of claim 14, further comprising monitoring, by the system, the donor information with respect to social media information of a target organization.

17. A non-transitory machine-readable storage medium, comprising executable instructions that, when executed by a processor, facilitate performance of operations, comprising:
receiving donor information over a period of time; and
recording the donor information in a blockchain stored on a blockchain network as the donor information is received over the period of time.

18. The non-transitory machine-readable storage medium of claim 17, wherein the operations further comprise:
collecting social media data corresponding to a donor; and
recording the social media data in the blockchain.

19. The non-transitory machine-readable storage medium of claim 18, wherein the operations further comprise:
collecting donation data and donor personal information corresponding to the donor; and
recording the donation data and the donor personal information in the blockchain.

20. The non-transitory machine-readable storage medium of claim 19, wherein the operations further comprise:
determining an overall influence score of the donor by calculating a social media score, an independent engagement score, and an influence score from the social media data stored in the blockchain; and
recording the overall influence score in the blockchain.
